(19) United States
(12) Patent Application Publication
(10) Pub. No.: US 2003/0213349 A1
(43) Pub. Date: Nov. 20, 2003

(54) Table saw having a workpiece positioning and push cutting device

(76) Inventor: Chin-Chin Chang, Taichung Hsien (TW)

Correspondence Address: Connolly Bove Lodge & Hutz LLP, P.O. Box 2207, Wilmington, DE, 19899-2207, US

(21) Appl. No.: 10/150,682

(22) Filed: May 16, 2002

(51) Int. Cl. B26D 7/06; B26D 1/18; B27B 3/28; B23D 19/00; B27B 27/04

(52) U.S. Cl. 83/438; 83/477.2

(57) ABSTRACT

A table saw includes a workpiece positioning and push cutting device mounted on the working table of the base, and including a seat board, a slide board, and a push seat. The seat board is selectively secured on one of the two sides of the working table of the base. The slide board is slidably mounted on the seat board. The push seat is pivotally mounted on the slide board, and may be used to adjust the inclined angle of the workpiece to be cut. Thus, the table saw is available for both of the right-handed user and the left-handed user. In addition, the inclined angle of the push seat may be adjusted exactly, so that the workpiece may have an exact inclined angle relative to the saw blade, thereby enhancing the cutting precision of the table saw.

### BACKGROUND OF THE INVENTION

1. Field of the Invention

The present invention relates to a table saw having a workpiece positioning and push cutting device, and more particularly to a table saw having a workpiece positioning and push cutting device, wherein the table saw is available for both of the right-handed user and the left-handed user.

2. Description of the Related Art

A conventional table saw in accordance with the prior art comprises a saw blade adjusting mechanism for adjusting the inclined cutting angle of the saw blade, so that the saw blade may be used to cut the workpiece in an inclined manner. However, the inclined angle cutting angle of the saw blade cannot be adjusted easily and exactly, thereby causing inconvenience to the user, and thereby decreasing the precision of cutting the workpiece. In addition, the conventional saw blade adjusting mechanism cannot be assembled easily and conveniently, and has a high cost of fabrication due to its complicated construction.

### SUMMARY OF THE INVENTION

The present invention has arisen to mitigate and/or obviate the disadvantage of the conventional saw blade adjusting mechanism of the table saw.

The primary objective of the present invention is to provide a table saw having a workpiece positioning and push cutting device, wherein the table saw is available for both of the right-handed user and the left-handed user.

Another objective of the present invention is to provide a table saw having a workpiece positioning and push cutting device, wherein the inclined angle of the push seat may be adjusted exactly, so that the workpiece may have an exact inclined angle relative to the saw blade, thereby enhancing the cutting precision of the table saw.

In accordance with the present invention, there is provided a table saw having a workpiece positioning and push cutting device, comprising a base having a working table, and a workpiece positioning and push cutting device mounted on the working table of the base, the workpiece positioning and push cutting device including a seat board, a slide board, and a push seat, wherein:

the working table of the base has a first side and a second side;

the seat board is selectively secured on the first side or the second side of the working table of the base;

the slide board is slidably mounted on a top face of the seat board, and is formed with a positioning slot; and

the push seat is pivotally mounted on a top face of the slide board, and is formed with a slot, a bolt is in turn extended through the positioning slot of the slide board and the slot of the push seat, and is screwed into an adjusting rotation knob.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a table saw having a workpiece positioning and push cutting device in accordance with a preferred embodiment of the present invention;

FIG. 2 is an exploded perspective view of the table saw having a workpiece positioning and push cutting device as shown in FIG. 1;

FIG. 3 is a side plan cross-sectional view of the table saw having a workpiece positioning and push cutting device taken along line 3-3 as shown in FIG. 2;

FIG. 4 is a side plan cross-sectional view of the table saw having a workpiece positioning and push cutting device taken along line 4-4 as shown in FIG. 2;

FIG. 5 is a side plan cross-sectional assembly view of the table saw having a workpiece positioning and push cutting device as shown in FIG. 2; and

FIG. 6 is a top plan schematic operational view of the table saw having a workpiece positioning and push cutting device as shown in FIG. 1 in use.

### DETAILED DESCRIPTION OF THE INVENTION

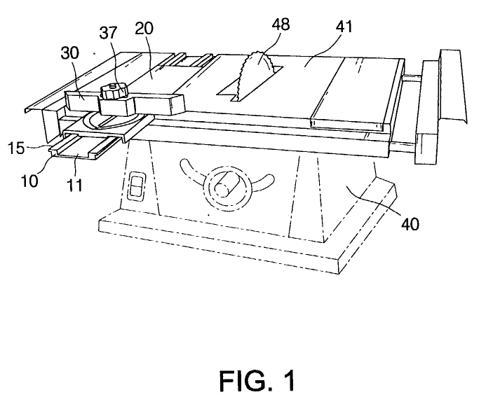

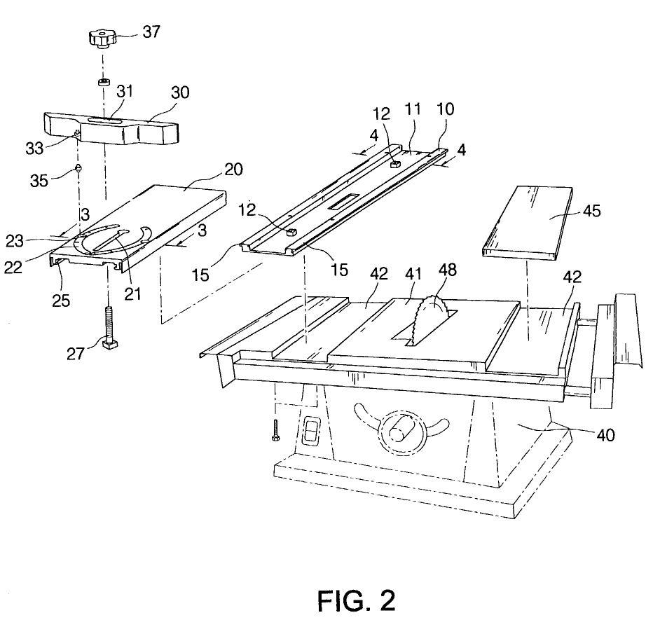

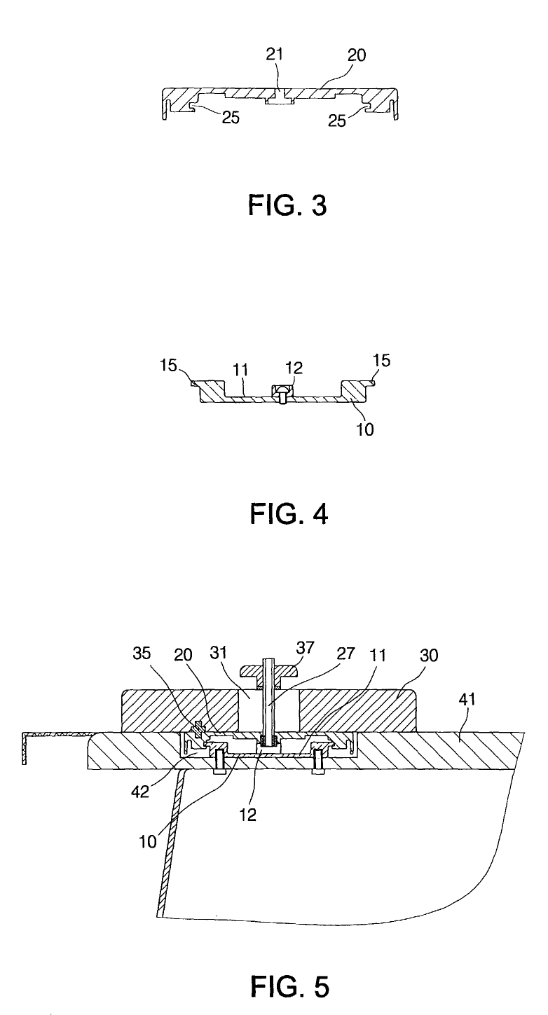

Referring to the drawings and initially to FIGS. 1-5, a table saw having a workpiece positioning and push cutting device in accordance with a preferred embodiment of the present invention comprises a base 40 having a working table 41, and a workpiece positioning and push cutting device mounted on the working table 41 of the base 40.

The workpiece positioning and push cutting device includes a seat board 10, a slide board 20, and a push seat 30.

The seat board 10 is screwed on the working table 41 of the base 40. The seat board 10 is a substantially rectangular fixing guide board. The seat board 10 has a top face provided with two symmetric protruding guide rails 15 and formed with a rectangular recessed seat 11 located between the two guide rail 15. The seat board 10 is provided with two opposite catch blocks 12 each screwed on a top face of the recessed seat 11 of the seat board 10.

The slide board 20 is a substantially rectangular board for placing a workpiece to be cut, and is slidably mounted on the top face of the seat board 10. The slide board 20 has a bottom face formed with two opposite slide channels 25 each slidably mounted on one of the two guide rail 15 of the seat board 10, so that the slide board 20 may slide on the seat board 10 longitudinally. The slide board 20 is longitudinally formed with a positioning slot 21, and is provided with a scale disk 23 surrounding a periphery of the positioning slot 21. The slide board 20 has a top face formed with a shaft hole 23.

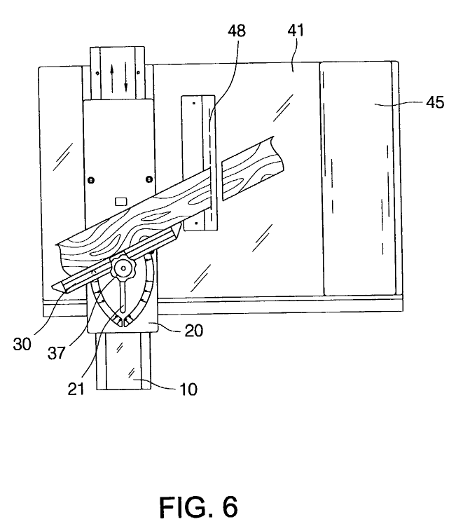

The push seat 30 is a hand-held type push cutting catch seat that may adjust the cutting angle of the workpiece as shown in FIG. 6. The push seat 30 is pivotally mounted on the top face of the slide board 20, and has a bottom face formed with a shaft hole 33. The push seat 30 is provided with a pivot shaft 35 pivotally mounted between the shaft hole 23 of the slide board 20 and the shaft hole 33 of the push seat 30, so that the push seat 30 may be pivoted on the top face of the slide board 20 about the pivot shaft 35, so as to adjust the included angle between the push seat 30 and the slide board 20. The push seat 30 is transversely formed with a slot 31. A bolt 27 is in turn extended through the positioning slot 21 of the slide board 20 and the slot 31 of the push seat 30, and is screwed into an adjusting rotation knob 37.

After the adjusting rotation knob 37 is rotated and unscrewed from the bolt 27, the push seat 30 may be pivoted, so as to adjust the included angle between the push seat 30 and the slide board 20, so that the workpiece rested on the front side of the push seat 30 may have an exact positioning and cutting angle.

The head of the bolt 27 may be moved reciprocally, and movement of the head of the bolt 27 is limited by the two catch blocks 12 of the seat board 10, so that when the slide board 20 is pushed to slide on the seat board 10, the slide board 20 may be retained by the two catch blocks 12 of the seat board 10, thereby preventing the slide board 20 from detaching from the seat board 10 during movement.

In practice, the working table 41 of the base 40 is formed with two opposite recessed mounting seats 42, and is provided with a saw blade 48 located between the two mounting seats 42. Thus, the workpiece positioning and push cutting device of the present invention may be mounted on one of the two mounting seats 42 of the working table 41 of the base 40, and a cover plate 45 may be secured in the other mounting seat 42 of the working table 41 of the base 40.

In such a manner, the workpiece positioning and push cutting device may be selectively mounted on one of the two mounting seats 42 of the working table 41 of the base 40 according to the user's requirements, thereby facilitating the user operating the table saw and pushing the push seat 30, so that the table saw having a workpiece positioning and push cutting device of the present invention is available for both of the right-handed user and the left-handed user.

In assembly, the seat board 10 is selectively screwed on one of the two mounting seats 42 of the working table 41 of the base 40, the cover plate 45 may be secured on the other mounting seat 42 of the working table 41 of the base 40.

When the user wishes to adjust the cutting angle of the workpiece to be cut, the adjusting rotation knob 37 may be rotated and unscrewed from the bolt 27, to release the urging state between the push seat 30 and the slide board 20, so that the push seat 30 may be pivoted about the pivot shaft 35, so as to adjust the included angle between the push seat 30 and the slide board 20, and to adjust the included angle between the push seat 30 and the saw blade 48 as shown in FIG. 6. The included angle adjustment of the push seat 30 may be performed according to the scale disk 22 of the slide board 20.

After the inclined angle of the push seat 30 is adjusted, the adjusting rotation knob 37 may be rotated and tightened, to push and urge the push seat 30 on the slide board 20, so that the push seat 30 is fixed on the slide board 20, and cannot be pivoted freely. Thus, the push seat 30 together with the slide board 20 may slide on the seat board 10, to push the workpiece forward to be cut by the saw blade 48 as shown in FIG. 6.

In such a manner, the inclined angle of the push seat 30 may be adjusted exactly, so that the workpiece may have an exact inclined angle relative to the saw blade 48, thereby enhancing the cutting precision of the table saw.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A table saw having a workpiece positioning and push cutting device, comprising a base having a working table, and a workpiece positioning and push cutting device mounted on the working table of the base, the workpiece positioning and push cutting device including a seat board, a slide board, and a push seat, wherein:
the working table of the base has a first side and a second side;
the seat board is selectively secured on the first side or the second side of the working table of the base;
the slide board is slidably mounted on a top face of the seat board, and is formed with a positioning slot; and
the push seat is pivotally mounted on a top face of the slide board, and is formed with a slot, a bolt is in turn extended through the positioning slot of the slide board and the slot of the push seat, and is screwed into an adjusting rotation knob.

2. The table saw having a workpiece positioning and push cutting device in accordance with claim 1, wherein the seat board has a top face provided with two symmetric protruding guide rails and formed with a rectangular recessed seat located between the two guide rail, and the slide board has a bottom face formed with two opposite slide channels each slidably mounted on one of the two guide rail of the seat board, so that the slide board may slide on the seat board longitudinally.

3. The table saw having a workpiece positioning and push cutting device in accordance with claim 2, wherein the seat board is provided with two opposite catch blocks each screwed on a top face of the recessed seat of the seat board, and the bolt may has a head whose movement is limited by the two catch blocks of the seat board.

4. The table saw having a workpiece positioning and push cutting device in accordance with claim 1, wherein the slide board is provided with a scale disk surrounding a periphery of the positioning slot.

5. The table saw having a workpiece positioning and push cutting device in accordance with claim 1, wherein the slide board has a top face formed with a shaft hole, the push seat has a bottom face formed with a shaft hole, the push seat is provided with a pivot shaft pivotally mounted between the shaft hole of the slide board and the shaft hole of the push seat, so that the push seat is pivoted on the top face of the slide board about the pivot shaft, so as to adjust an included angle between the push seat and the slide board.

6. The table saw having a workpiece positioning and push cutting device in accordance with claim 1, wherein the working table of the base is formed with two opposite recessed mounting seats, and the seat board is selectively secured on one of the two mounting seats of the working table of the base.

7. The table saw having a workpiece positioning and push cutting device in accordance with claim 6, further comprising a cover plate selectively secured on one of the two mounting seats of the working table of the base.
